(19) United States
(12) Patent Application Publication
(10) Pub. No.: US 2006/0024641 A1
(43) Pub. Date: Feb. 2, 2006

(54) Aspirator having cushioned tip

(76) Inventor: Lee A. Mahlmann, Rosenberg, TX (US)

Correspondence Address: JAMES L. JACKSON;James L. Jackson, P.C., 10723 Sugar Hill Dr., Houston, TX, 77042, US

(21) Appl. No.: 10/909,725

(22) Filed: Aug. 2, 2004

(51) Int. Cl. A61C 17/06

(52) U.S. Cl. 433/96; 433/91

(57) ABSTRACT

A disposable cushioned aspirator which forms part of a dental or medical aspirating system. The disposable cushioned aspirator appliance described herein is intended principally to be used in dental procedures where bodily fluids and rinse water is evacuated from a patient's mouth, but the invention has application in medical procedures and various other applications as well. An elongate tubular element having a patient end and a connection end is exteriorly lined with a layer of soft cushioning material such as a soft polymer material, rubber or a porous foam material to protect the soft tissues in and around the mouth of a patient. The elongate tubular aspirator is capable of being manually bent from an initially straight configuration to a curved or other desired configuration and is provided with a structural member extending along its length and being pliable to permit bending and yet of sufficient structural integrity to maintain the aspirator in the desired configuration during use. The structural member is preferably a wire element which is embedded within or attached to the elongate tubular element.

### RELATED PATENT

The present invention is related to the subject matter of U.S. Pat. No. 6,068,477, entitled “Foam Cushioned Aspirator”, filed on Jul. 6, 1999 by Lee A. Mahlmann and issued on May 30, 2000.

### RELATED PROVISIONAL APPLICATION

Applicant hereby claims the benefit of U.S. Provisional Patent Application No.______, filed on Oct. 23, 2003 by Lee A. Mahlmann and entitled “Aspirator Having Cushioned Section”.

### BACKGROUND OF THE INVENTION

1. Field of the Invention

This invention relates generally to tubular appliances such as tubular aspirators, intubation members and the like for use by medical and dental practitioners for suction enhanced removal of fluid or drainage of fluid from the immediate region of a medical or dental procedure. More particularly, the present invention concerns an aspirator for aspiration of fluids, including body fluids such as blood, saliva, other fluids such as rinse water and the like, as well as fluid entrained solids and other fluid-like materials from a region of interest, such as the oral cavity or a body incision or wound. The present invention also concerns a cushioned tubular appliance for substantially eliminating the potential for aspiration of soft flaccid tissues into aspirator openings and simultaneously protecting such tissues from being pinched or otherwise damaged by hard portions of an aspirator tube. This invention also concerns tubular cushioned intubation members that can be configured for efficient use by surgeons for drainage of fluid from a surgical site. Even more particularly, the present invention concerns the provision of a tubular aspirator having a terminal section provided with a soft, cushioned external aspirator layer for contact with body tissues at a specific aspiration site to prevent damage to body tissues and to promote the general comfort of the patient. The present invention also concerns a tubular aspirator having a terminal section provided with a cushioning external layer forming an aspirator tip that defines a plurality of contoured fluid transfer openings that may be of elongate, round or other suitable configuration, having sufficient cross-sectional dimension for optimum transfer of fluid and being of sufficiently small dimension to minimize the potential for ingress of flaccid tissue into the openings during aspiration activity.

2. Description of the Prior Art

While aspirator devices are used in a wide variety of medical and dental applications, to promote easy understanding of the present invention it is discussed herein particularly as the invention is employed for oral aspiration in the field of dentistry, including orthodontics. The present invention also has application in the field of surgery. For example, the present invention also has application as an intubation member that can be configured by a surgeon during a surgical procedure for efficient drainage of fluid from a surgical site and can be re-configured by the surgeon or nursing personnel as needed to promote efficient drainage of body fluid. The tissue inside the human mouth and lip area around the mouth is very sensitive and is easily damaged when aspiration occurs. In most dental procedures, a tubular saliva ejector or aspirator is connected to a source of suction and is used to remove the fluid that is typically present and thus dry the mouth so that a dental or medical procedure can be carried out without the inconvenience of a wet field. The problem with most tubular saliva ejectors or aspirators is that they are typically composed of a hard, non-forgiving plastic or metal and define a large diameter end opening. When positioned under the tongue or in the labial vestibule of a patient's oral cavity, the saliva ejector aspirates saliva, blood, and unfortunately also aspirates the soft, flaccid, easily damaged oral tissues that are present so that the tissue is pulled into the aspirator opening, blocking the opening and subjecting the soft tissue to significant vacuum induced force. Once the tissue is aspirated into the holes of a saliva ejector a blood blister is often created. When the aspirator tube is removed from the mouth as suction is being applied, pulling it away from the patient's tissue is very painful to the patient and often causes a “blood blister” to remain. Not only does a hard plastic or metal aspirator cause discomfort inside the mouth of a patient but often pinches the lower lip against the lower teeth. This occurrence typically causes pain to the lip and can actually cause bruising of the lip. The discomfort that a hard aspirator can cause during a dental procedure can greatly affect the outcome of the dental procedure. An uncomfortable patient is not as cooperative as a comfortable one. The end result can be less than ideal.

### SUMMARY OF THE INVENTION

The tubular aspirator appliance of the present invention is designed to be the initial or fluid inlet section of a dental or medical aspirating system. The aspirator appliance is designed, for example, for an end portion of the aspirator to be inserted into a patient's mouth, with suction being applied to remove collected saliva/water by means of suction. The aspirator appliance is attached to a remote central vacuum unit by way of a flexible tube having a conventional vacuum line connection for medical and dental operators. The present invention is unique in that it has a skeletal structure made up of a flexible polymer tube in which a rather stiff wire is embedded to allow the aspirator to be bent or otherwise formed to a specific shape for a specific dental or medical procedure and to remain so bent until subsequently bent to another shape. An end portion or section of the skeletal polymer tube is provided with a cushioning covering composed of a soft rubber or rubber-like cushioning material or a non-toxic, open cell, foam material that protects not only the soft tissue within the mouth but all tissues around the mouth. The external cushioning covering of the aspirator device of the present invention has cushioning material that extends along a desired section of the appliance and provides a cushioning end that extends beyond the inlet end of the aspirator tube and defines a plurality of fluid transfer openings that provide for efficient aspiration of fluid and minimize entry of flaccid tissue into the fluid transfer openings during use. The aspirator has an end connection part that is attached to the central vacuum tubing by means of a conventional medical/dental vacuum line connection. Thus the cushioning effect of the aspirator of this invention protects not only the soft tissue within the mouth but also the teeth and lips of the patient.

The actual design of the aspirator is very simple. The aspirator consists of a desired length plastic tube, strong enough to withstand strong suction. The aspirator tube has a wire imbedded in it and extending longitudinally, substantially the full length of the tube. The embedded wire allows the aspirator tube to be formed to any desired shape to fit different dental or medical procedures. Under circumstances where the aspirator tube is not intended to be deformed by bending, the aspirator may be manufactured without an embedded wire or structural member. A desired section of the aspirator tube, which may be the aspirator tip, or even a major section of the aspirator tube, is covered at least partially by a soft cushioning material that is located for contact with the oral tissues of the patient and protects the oral tissues, the lips and the teeth of a patient from aspirator contact injury. The aspirator tube has a small connecting section that releasably connects the aspirator to a vacuum tube extending from the central vacuum source of a dental or medical operatory.

The formable-cushioned tip aspirator of the present invention designed for multiple sizes and tip designs can eliminate the problems caused by a hard plastic or metal aspirator. A soft, cushioned outer covering of foam or rubber-like material at the aspirator tip covers a portion of the tubular aspirator and provides an aspiration end for contact with the tissues of the patent. The aspirator end defines a plurality of fluid transfer openings having optimum cross-sectional dimension and contoured configuration for efficient fluid transfer and with the fluid transfer openings designed so as not allow the aspirator to impinge, aspirate, or bruise any tissue in or around the oral cavity of a patient. The fluid transfer openings may be of elongate, round, oval or of other suitable configuration and are oriented in peripherally spaced relation so that one or more of the openings remain unobstructed to permit suction flow even when the aspirator tip is placed in a small or tight region of the oral cavity. This aspirator tip design is not only optimized for use in dentistry but can also be utilized in many medical applications. It is gentle to all soft tissues that it contacts and yet is efficient for fluid removal from the site of a dental or medical procedure.

The resilient covering of the aspirator tube has a rounded end portion that extends beyond the inlet end of the aspirator tube. This rounded end portion defines a plurality fluid transfer openings of elongate, round, oval or any other suitable cross-sectional configuration having a sufficiently minimal width to minimize the potential for suction induced movement of flaccid tissues into the fluid transfer or aspiration openings and have a length, width that or other dimension that is sufficient to define fluid transfer openings of adequate cross-sectional dimension for efficient aspiration of fluid and yet fluid transfer openings that are sufficiently small that flaccid tissue will not tend to enter and block the openings. Further, the plurality of fluid transfer openings are spaced about the rounded end portion of the tip and oriented to ensure that one or more of the fluid transfer openings will remain open for fluid aspiration even when the tip of the aspirator is placed within a small or tight region of the cavity being subjected to aspiration. When the aspiration openings are defined in or by open call foam material the openings can effectively take the form of a multitude of foam material openings and interstices that essentially permit aspirated fluid to be forced through the foam material by the vacuum source.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the preferred embodiment thereof which is illustrated in the appended drawings, which drawings are incorporated as a part hereof.

It is to be noted however, that the appended drawings illustrate only a typical embodiment of this invention and are therefore not to be considered limiting of its scope, for the invention may admit to other equally effective embodiments.

In The Drawings

FIG. 1 is a side view of a formable cushioned aspirator having a cushioned end section or tip and representing the preferred embodiment of the present invention, the aspirator being shown in the substantially straight non-bent form thereof;

FIG. 2 is a longitudinal sectional view of the formable-cushioned aspirator of FIG. 1;

FIG. 3 is a sectional view taken along line 3-3 of FIG. 2;

FIG. 4 is a sectional view taken along line 4-4 of FIG. 2 and showing the relationships of the flexible tube element and the structural wire;

FIG. 5 is an elevational view showing the formable cushioned aspirator of the present invention being bent to a curved form particularly for dental application;

FIG. 6 is an end view taken along line 6-6 of FIG. 2 and showing the patient end or tip of the formable aspirator device:

FIG. 7 is a partial side elevational view of an alternative embodiment of the present invention, showing the cushioned tip thereof having fluid transfer openings of oval configuration;

FIG. 8 is a partial side elevational view of another alternative embodiment of the present invention, showing the cushioned tip thereof having fluid transfer openings of round configuration;

FIG. 9 is a partial side elevational view of another alternative embodiment of the present invention, showing an aspirator tip being composed of open cell polymer foam material which defines interstices that collectively define the fluid transfer passage system of the aspirator;

FIG. 10 is a sectional view taken along line 10-10 of FIG. 9; and

FIG. 11 is a partial side elevational view showing an alternative embodiment of the present invention incorporating a tubular element having a formable structural member embedded therein and having a resilient tip member defining a rounded end having external fluid channels or grooves and having a single end opening.

### DETAILED DESCRIPTION OF PREFERRED EMBODIMENT

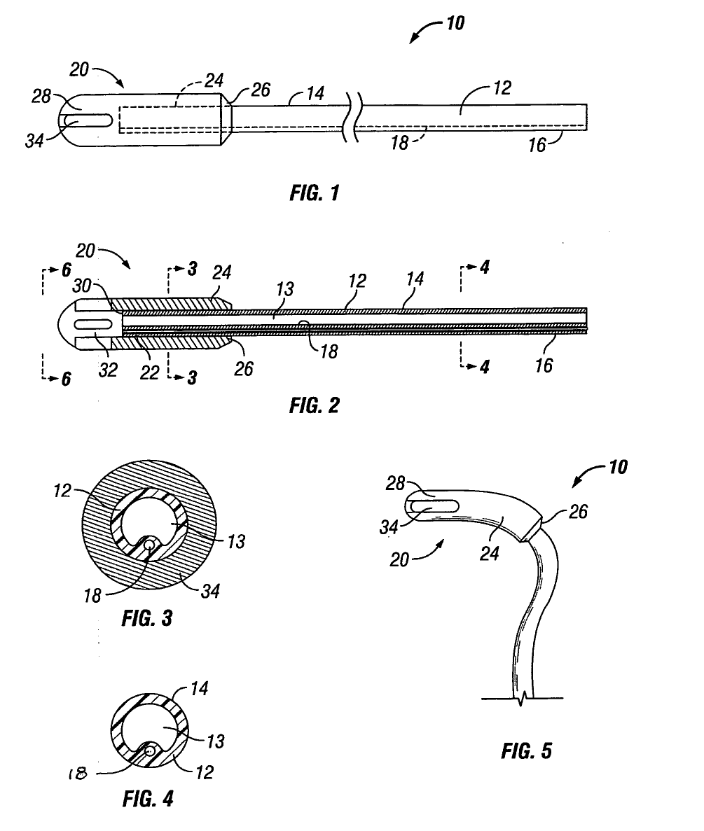

Referring now to the drawings and first to FIGS. 1-5, a disposable formable cushioned aspirator representing the preferred embodiment of the present invention is shown generally at 10. The formable-cushioned aspirator 10 consists of an elongated hollow flexible tube 12 preferably composed of a suitable polymer or rubber and defining a generally cylindrical external surface 14 extending substantially the entire length thereof. The elongate flexible hollow tubular element 12 has a central flow passage 13 and defines a connector end section 16 to which is assembled a suction tube connector 17 that enables attachment of the formable cushioned aspirator 10 to the usual flexible tube of a central vacuum pump or vacuum system (not shown). The flexible tubing and the suction tube connector 17 may be of conventional nature, but preferably it is fixed to the connector end section 16 of the flexible hollow tubular element 12. This feature permits an aspirator to be releasably assembled to a suction tube so that it can be easily removed and disposed of in a manner that prevents any potential for cross-contamination between patients. The connector end section 16 of the flexible hollow tubular element 12 of the aspirator can range in size for example from about 10 mm to about 35 mm or it may be of smaller or greater dimension if desired.

Within the flexible hollow tubular element 12 is an embedded a formable structural member such as a fairly rigid wire 18 which is preferably composed of soft and pliable metal such as stainless steel, mild steel, aluminum alloy or any suitable non-metal material that can be bent and take a set so that it remains in its bent configuration. The formable structural member 18 within the aspirator permits the aspirator to be bent by the practitioner during a dental or surgical procedure to conform to a specific configuration for efficient use (FIG. 5) and permits the configuration of the aspirator to be altered as desired. The wire size is of sufficient diameter that it can be easily manually bent by a dental or medical practitioner or assistant to perform its necessary configuration retaining function, but the wire is not so large as to inhibit the suction capacity of the flexible hollow tubular element 12. The structural integrity of the stainless steel wire 18 is sufficient to permit the cushioned aspirator to be manually bend to a desired configuration and to maintain the desired configuration during use. In some applications where the aspirator tube does not need to be bent to a desired configuration and remain bent, the formable structural member or wire 18 can be eliminated, leaving the flexible hollow tubular element 12 to form the basic structure of the aspirator. In this case it should be noted that the flexible hollow tubular element 12 will have sufficient flexibility that it can be manually flexed to a desired configuration to accomplish a desired task. When the manually applied flexing force is dissipated, the flexible hollow tubular element 12 will return to its original, substantially straight configuration due to its elastic memory. The flexible hollow tubular element 12 can have an inside diameter ranging from a minimum of about 3 mm to whatever size meets the needs of the practitioner.

To provide the aspirator structure with a cushioning capability in the region of its contact with the tissue of the patient and to facilitate efficient vacuum induced fluid retrieval, the flexible hollow tubular element 12 is provided with a flexible cushioning tip shown generally at 20. The flexible cushioning tip 20 is preferably composed of a soft flexible polymer or rubber material or may be composed of a polymer foam material as desired. The flexible cushioning tip 20 can be molded onto the suction or fluid transfer end 22 of the flexible hollow tubular element 12 if desired or it can be manufactured as a separate component and placed in assembly on the tubular element 12. The length of the flexible cushioning tip 20 may vary from a minimum length of about 4 cm to a maximum of about 12 cm or more. If desired, the flexible tubular tip element may extend virtually the entire length of the tubular element 12. The thickness of the flexible cushioning tip 20 covering the hollow plastic tube 12 may range from about 1 mm to about 10 mm or whatever thickness is needed to meet the cushioning effect that is desired. The normal thickness range of the flexible cushioning tip 20 is from about 1 mm to about 3 mm. The overall length of the cushioned aspirator 10 can be variable depending on dental or medical procedure it is being used for. For a dental procedures the average length of the cushioned aspirator 10 would range from for example from about 90 mm to about 150 mm.

The flexible cushioning tip 20 of the patient end, i.e., suction or fluid transfer end 22 of the aspirator, as shown in FIGS. 1-6, through which saliva/blood/water and debris is aspirated into the flexible hollow plastic tube 12. The flexible cushioning tip 20 is of tubular form defining a generally cylindrical wall 24 that fits closely about the external generally cylindrical surface 14 or is formed onto the generally cylindrical wall 24 such as by molding. The wall 24 of the flexible cushioning tip 20 terminates at one end with a tapered end section 26 that merges the flexible cushioning tip with the external cylindrical surface 14 of the flexible hollow plastic tube 12. This feature minimizes the potential for fluid or debris to be retained at the juncture of the flexible cushioning tip with the flexible hollow plastic tube 12.

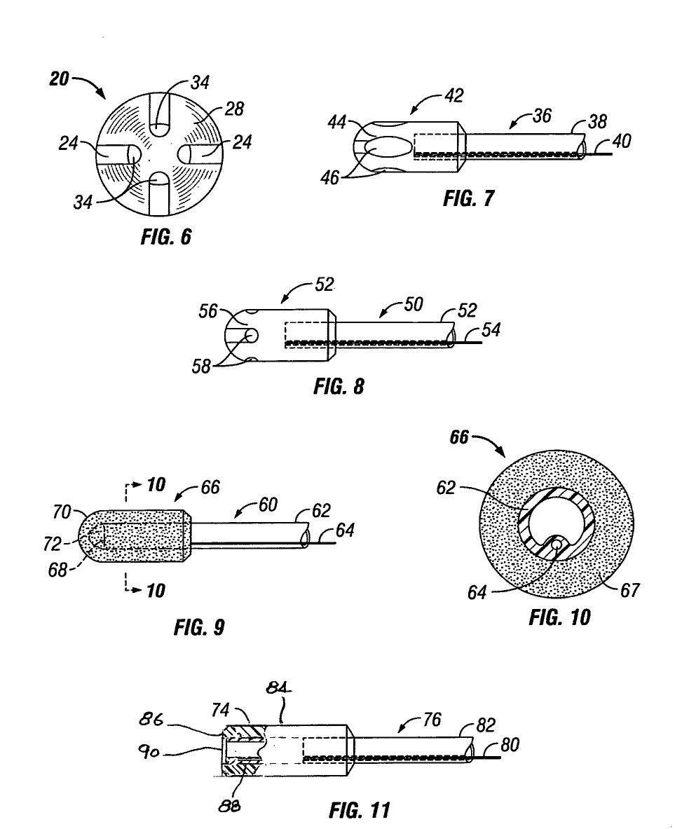

flexible cushioning tip 20 defines a closed, rounded distal end 28 that projects beyond the remote or distal end 30 of the flexible hollow plastic tube 12 and thus, with the flexible hollow plastic tube 12, defines a fluid transfer chamber 32 that is in fluid communication with the central flow passage 13. The closed rounded distal end 28 of the flexible cushioning tip 20 defines a plurality of fluid transfer openings 34 which, as shown in FIG. 6 are oriented in outward radiating fashion, there being shown four radiating fluid transfer openings 34 in the Figure. It should be borne in mind however, that the closed rounded distal end 28 of the flexible cushioning tip 20 need only define a single fluid transfer opening in order for vacuum induced fluid aspiration to occur. The outwardly radiating fluid transfer or liquid aspiration openings, which are evenly distributed about the periphery of the closed rounded distal end of the flexible cushioning tip, assure that at least one of the fluid transfer openings will remain open even when the flexible cushioning tip is inserted into a close or tight region within a body cavity of a patient. This feature effectively minimizes the potential that all of the fluid aspiration openings will become simultaneously blocked by flaccid tissue of the patient and allows efficient vacuum induced flow of air and fluid to continuously occur even though some of the fluid transfer openings may become blocked. Thus the vacuum induced force that is applied to some of the flaccid tissue remains low, even though efficient aspiration occurs; thus the flaccid tissue is not subjected to sufficient vacuum induced force that blood blisters or aspirator induced pain will tend to occur.

The aspirator construction of the present invention is shown in three different forms. FIGS. 1-6 show the flexible cushioning tip 20 being provided with multiple fluid transfer or liquid aspiration openings 34 that are evenly spaced about the periphery of the closed rounded distal end 28 and are oriented in outwardly facing radiating relation. The fluid transfer openings range in size from about 0.5 mm to about 2 mm across or in diameter. When the openings are of elongate, essentially slotted form, they have a transverse dimension in the range of about 0.5 to 2 mm and a length of from about 1 cm to 1.5 cm, the narrow width thereof tending to retard entry of flaccid tissue that might otherwise block the openings.

FIG. 7 represents an alternative embodiment of the present invention which shows the distal end portion of an aspirator 36 embodying the principles of the present invention and shows a flexible aspirator tube 38 within which is located a formable structural element 40 such as a wire member. It should be noted that the wire member 40 does not normally extend beyond the end of the flexible tubular element 38, but rather is shown in FIGS. 7, 8, 9 and 11 of the drawings to facilitate ready understanding of this invention. Typically the wire member is embedded within the flexible polymer material of the tubular element and extends from end to end thereof. The flexible tubular element is typically manufactured in long lengths by extruding the polymer material about a length of wire in similar manner to the manufacture of coated electrical wire and cable. Then the long length of tubular material is cut into desired sections having a length that is suitable for use in fluid aspiration and for use during surgical intubation. About the flexible aspirator tube 38 is positioned a flexible cushioning aspirator tip shown generally at 42 having a closed rounded distal end 44 defining a plurality of aspirator openings 46 of oval configuration to allow aspiration of not only saliva, water, and blood, but also fairly large debris particles.

Another alternative embodiment of the present invention is shown generally at 50 in FIG. 8 which shows the distal end portion of a flexible aspirator tube 52 having a formable structural member 40 such as a wire member. A flexible cushioning aspirator tip shown generally at 52 is positioned about the distal end portion of a flexible aspirator tube 54 and defines a closed rounded distal end 56 defining a plurality of fluid transfer or aspirator openings 58 of circular configuration to allow aspiration of fluid from a cavity of interest.

A further embodiment of the present cushioned aspirator invention is shown generally at 60 in FIG. 9 wherein a flexible tubular member 62, preferably composed of a polymer or rubber material, is provided with a formable structural member 64 such as an embedded wire that extends substantially the entire length thereof. A flexible cushioning aspirator tip of tubular form is shown generally at 66 and defines a tubular wall 67 that is composed of a closed cell polymer foam material that may be molded or otherwise positioned about the distal end portion 68 of the flexible tubular member 62. A rounded closed distal end 70 of the flexible cushioning aspirator tip 66, which is integral with the tubular wall 67, defines a multitude of interstices that serve as aspiration passages that permit fluid to be drawn through the flexible cushioning aspirator tip and into an internal fluid transfer chamber 72 and thence through the internal flow passage of the flexible aspirator tube 62 toward the source of vacuum.

As noted in FIGS. 9 and 10, the tubular foam covering of the aspirator tip extends from about 2 mm to about 4 mm past the patient or distal end 68 of the flexible hollow tube 62 to provide for a cushioned effect when the patient or distal end of the foam-cushioned aspirator is moved into engagement with soft or flaccid tissue of the patient. This feature effectively prevents damage to the soft tissue of the patient if the tissue comes into contact with the external surface of the aspirator tip.

Regarding FIGS. 9 and 10, it should be noted that the foam-cushioned aspirator with a closed foam tip 28 requires that suction be applied through the porous foam cushioning material. The foam in this application would need to be porous enough to allow for suction to occur and to allow typically occurring liquid material to flow through the foam material and into the aspirator tube. Polyurethane foam would best suit this purpose and comes in two types; polyether based and polyester based. The polyether based foam is considered preferable because it has greater flexibility and allows for greater suction/air flow rate.

The embodiment of FIG. 11, shown generally at 76 comprises a flexible polymer tubular element 82 having an elongate formable structural member 80 embedded therein and extending along the length thereof. Here again, the elongate formable structural member or wire 80 is shown to extend beyond a portion of the flexible tubular element 82 only for the purpose of simplicity and understanding. In practice, the embedded wire 80 will normally extend from end to end of the flexible tubular element 82, though in some limited circumstances it may be desirable that the wire extend beyond one of the ends thereof. A generally cylindrical tubular tip member 84 having a rather blunt end 86 is placed over an end 88 of the flexible polymer tubular element 82 and, together with the end opening of the tubular element 82, defines a single end opening 90. The end opening 90 is effective for aspiration of fluid material and debris and is also effective for fluid drainage when the formable cushioned tubular appliance is utilized for intubation at a surgical site. It should be borne in mind that the tubular tip element 84 may extend along any suitable length of the tubular element 82, thus it is not intended to restrict the spirit and scope of the present invention to the specific embodiment that is shown.

The aspirator described is made up of both solid plastic and porous or non-porous plastic foam. Both parts can be made from non-toxic materials such as polyurethane, rubber, latex, polyethylene, polyvinyl chloride, or vinyl polymides. The materials used to make these parts would be chosen and dimensioned to meet specific operative characteristics.

The polymer foam material covering the hollow plastic tube could, if necessary, be glued or bonded. The foam material will most practically take the form of a sleeve of foam material which is positioned over the external surface of the elongate flexible aspirator tube. In most cases, the tubular foam covering would fit tight enough so glue or bonding material would not be necessary. If glue or bonding material is used to secure the polymer foam material to the elongate flexible tube, it should be of a non-toxic, water insoluable type. It is also envisioned that, according to some manufacturing processes, and within the spirit and scope of the present invention, the polymer foam material could be applied to the elongate flexible tube in an uncured state and permitted to cure in place.

Regardless of the particular embodiments shown and discussed herein, the flexible cushioning tip of the aspirator or intubation tube appliance is provided with a generally cylindrical tubular section that is received by the distal or aspirating end portion of the flexible aspirator tube and may have a length extending substantially the entire length of the aspirator tube or extending over a major portion of the aspirator tube, or extending over only an end portion of the aspirator tube as shown in the various Figures. The length of the flexible cushioning tip is thus determined by the needs of the user.

From the aspirating extremity 42 of the aspirator tube, the aspirator cap defines a semi-pointed or rounded closed distal end having a plurality of fluid transfer or aspirator openings that extend from a location near the distal end of the aspirator tube to the free or distal end of the flexible cushioning tip. As shown in the end view of FIG. 6, the flexible cushioning tip defines four aspirator slots, arranged at an angular spacing of about 90° and having outwardly facing radiating orientation. It should be borne in mind however, that the number of aspirator openings or slots may be greater than four or less than four and may be oriented at any desired angular spacing, such as three aspirator slots arranged at an angular spacing 120° or two aspirator slots arranged at an angular spacing of 180°, for example. For efficient aspiration of fluids, especially in the dental practice, where there is often significant flow of saliva and where a substantially dry field is desired, the combined cross-sectional area of the aspiration slots is preferably substantially equal to the cross-sectional area of the flow passage of the aspirator tube. Also, the aspirator slot orientation, with slots located at virtually all sides of the flexible cushioning tip, minimizes the potential that the aspirator slots can become blocked by flaccid tissue of the patient, such as is found within the oral cavity, and especially within the flexible cushioning tip is present within the labial vestibule or under the tongue of the patient. The fluid transfer or aspirator slots shown in the preferred embodiment of FIGS. 1-6 are of sufficiently narrow and elongate geometry and curve along the curved or rounded end of the aspirator cap, so that the soft tissue of the patient is unlikely to completely bridge and seal all of the aspirator openings. Thus, the suction of the aspirator pump is unlikely to establish a force differential that forces the soft tissue of the patient into the aspirator openings so that the formation of vacuum induced blood blisters is effectively minimized.

The present invention is in the form of an elongate formable tubular appliance that incorporates an elongate flexible tube defining an aspirator or drainage fluid flow passage and having a soft metal wire element embedded within the flexible tube. While the present invention is discussed herein particular as it relates to vacuum enhanced fluid aspiration it is not intended to limit the spirit and scope of the present invention to aspirators. Thus, the term “aspirators” is intended to encompass formable cushioned tubular appliances or elements that can be used for fluid drainage or fluid handling of any other similar character. The soft metal wire element provides sufficient structural integrity to permit the flexible tube to maintain any suitable bend configuration as desired by a dental or medical practitioner. The aspirator tube and the soft metal wire are bent manually to a desired configuration and will retain the desired bent configuration during use. Obviously, the bent configuration of the aspirator tube and its covering of cushioning material may be changed if desired by the practitioner. A cushioning covering, which is composed of a polymer foam material or a soft rubber or soft rubber-like polymer material is located externally of the aspirator tube and is bent to a desired configuration along with the aspirator tube. The cushioning covering defines a portion that extends along a significant length, i.e., from less than half to greater than half of the length of the aspirator tube according to the needs of the practitioner for the particular procedure that is in progress. Beyond the aspirating end of the aspirator tube the cushioning covering defines a plurality of fluid transfer openings. The exterior cushioning covering is flexible and will bend along with the aspirator tube as it is manually bent by the dental or medical practitioner.

In view of the foregoing, it is evident that the present invention is one well adapted to attain all of the objects and features hereinabove set forth, together with other objects and features which are inherent in the apparatus disclosed herein.

As will be readily apparent to those skilled in the art, the present invention may easily be produced in other specific forms without departing from its spirit or essential characteristics. The present embodiment is, therefore, to be considered as merely illustrative and not restrictive, the scope of the invention being indicated by the claims rather than the foregoing description, and all changes which come within the meaning and range of equivalence of the claims are therefore intended to be embraced therein.

I claim:

1. A formable cushioned tubular fluid handling appliance, comprising:
(a) an elongate tubular element defining a flow passage and having a connection end and a distal end and having sufficient flexibility for bending thereof to a desired configuration, said connection end being adapted for connection to a conventional aspirator suction connection fitting, said distal end defining an opening of said flow passage through which fluid is aspirated;
(b) a flexible cushioning tip having a tubular section being located about said distal end and being of sufficient thickness to present a cushioned aspirator surface for contact with the patient, said flexible cushioning tip having a closed end and together with said tubular section substantially enclosing said distal end of said elongate tubular element and defining a fluid transfer chamber beyond said distal end;
(c) at least one fluid transfer opening being defined in said closed end of said flexible cushioning tip and permitting vacuum induced aspiration of fluid into said fluid transfer chamber and through said flow passage of said elongate tubular element; and
(d) a length of formable structural material being fixed to said elongate tubular element and extending longitudinally thereof, said length of formable structural material being sufficiently pliable to permit bending of said elongate tubular element to a desired configuration and being of sufficient structural integrity to maintain said elongate tubular element at the desired bent configuration.

2. The formable cushioned tubular fluid handling appliance of claim 1, comprising:
said length of formable structural material being composed of wire.

3. The formable cushioned tubular fluid handling appliance of claim 1, comprising:
said length of formable structural material being embedded within said elongate tubular element and extending substantially the entire length thereof.

4. The formable cushioned tubular fluid handling appliance of claim 1, comprising:
(a) said elongate tubular element being composed of a polymer material; and
(b) said length of formable structural material being composed of wire and being embedded within said polymer material of said elongate tubular element and extending substantially the entire length of said elongate tubular element.

5. The formable cushioned tubular fluid handling appliance of claim 1, comprising:
(a) said elongate tubular element defining an inner surface; and
(b) said length of formable structural material being fixed to said inner surface of said elongate tubular element and extending substantially the entire length of said elongate tubular element.

6. The formable cushioned tubular fluid handling appliance of claim 1, comprising:
(a) said elongate tubular element defining an exterior surface; and
(b) said flexible cushioning tip having a tubular section being disposed about said exterior surface and having a closed end located beyond said distal end.

7. The formable cushioned tubular fluid handling appliance of claim 1, comprising:
(a) said elongate tubular element defining an exterior surface;
(b) said flexible cushioning tip being in the form of a porous closed cell polymer foam member having a tubular section being disposed about said exterior surface of said elongate tubular element; and
(c) said polymer foam material being fixed to said exterior surface of said elongate tubular element and defining said at least one fluid transfer opening.

8. The formable cushioned tubular fluid handling appliance of claim 1, comprising:
(a) said closed distal end of said flexible cushioning tip having a peripheral portion; and
(b) said at least one fluid transfer opening being a plurality of fluid transfer openings defined in said peripheral portion of said closed distal end and being oriented in substantially evenly spaced outwardly facing relation about said peripheral portion; and

9. The formable cushioned tubular fluid handling appliance of claim 1, comprising:
said flexible cushioning tip being a covering of porous foam material enclosing said distal end of said elongate tubular element and defining a multiplicity of pores through which fluid is caused to flow through said porous foam material and into said elongate tubular element under the influence of vacuum, said covering of porous foam material enclosing said distal end of said elongate tubular and element providing for cushioning of patient tissues at said plurality of fluid transfer openings.

10. The formable cushioned tubular fluid handling appliance of claim 1, comprising:
(a) said at least one fluid transfer opening being a single fluid transfer opening defined by said distal end of said elongate tubular element; and
(b) said flexible cushioning tip extending beyond said distal end of said elongate tubular element and defining at least one fluid transfer opening therein and providing for cushioning of patient tissue when said distal end of said formable cushioned aspirator is caused to contact patient tissue.

11. A formable cushioned tubular fluid handling appliance, comprising:
(a) an elongate tubular element defining a flow passage and having a connection end and a distal end and having sufficient flexibility for bending thereof to a desired configuration, said connection end being adapted for connection to a fluid receptacle, said distal end defining an inlet opening of said flow passage of said elongate tubular element; and
(b) a flexible cushioning tip having a tubular portion being disposed about said distal end and being of sufficient thickness to present a cushioned external surface for contact with a patient, said flexible cushioning tip having a distal end portion defining at least one fluid transfer opening disposed in communication with said flow passage and permitting flow of fluid there through and into said flow passage; and
(c) a length of formable structural material being fixed within said elongate tubular element and extending longitudinally thereof, said length of formable structural material being sufficiently pliable to permit bending of said cushioned aspirator to a desired configuration and of sufficient structural integrity to maintain said cushioned aspirator at the desired configuration.

12. The formable cushioned tubular fluid handling appliance of claim 11, comprising:
said length of structural material being composed of wire.

13. The formable cushioned tubular fluid handling appliance of claim 11, comprising:
said length of structural material being embedded within said elongate tubular element and extending substantially the entire length of said elongate tubular element.

14. The formable cushioned tubular fluid handling appliance of claim 11, comprising:
said flexible cushioning tip being frictional assembly with said elongate tubular element and defining a blunt distal end having a fluid transfer opening therein, said fluid transfer opening being in fluid communication with said flow passage.

15. The formable cushioned tubular fluid handling appliance of claim 11, comprising:
(a) said elongate tubular element defining an inner surface; and
(b) a length of formable structural material being fixed to said inner surface of said elongate tubular element and extending substantially the entire length of said elongate tubular element.

16. The formable cushioned tubular fluid handling appliance of claim 11, comprising:
(a) said elongate tubular element defining an exterior surface; and
(b) said flexible cushioning tip having a tubular section composed of polymer foam material enclosing a portion of said exterior surface;
(c) said flexible cushioning tip being fixed to said exterior surface of said elongate tubular element;
(d) said at least one fluid transfer opening being an opening into said distal end of said elongate tubular element; and
(e) said flexible cushioning tip enclosing said distal end of said elongate tubular element and defining a plurality of fluid transfer openings disposed in registry with said fluid transfer openings and providing for cushioning of patient tissues.

17. The formable cushioned tubular fluid handling appliance of claim 11, comprising:
said flexible cushioning tip being a covering of porous foam material enclosing said patient end of said elongate tubular element and defining a multiplicity of pores through which fluid is caused to flow through said porous foam material and into said elongate tubular element through said multiplicity of pores, said covering of porous foam material enclosing said distal end of said elongate tubular element and providing for cushioning of patient tissues at said plurality of fluid transfer openings.

18. The formable cushioned tubular fluid handling appliance of claim 11, comprising:
(a) said elongate tubular element defining a flow passage threthrough and defining an aspirator opening at said distal end thereof; and
(b) said flexible cushioning tip extending beyond said distal end of said elongate tubular element and providing for cushioning of patient tissue when said patient end of said cushioned aspirator is caused to contact patient tissue, said flexible cushioning tip defining a periphery extending beyond said distal end defining a fluid transfer chamber and having plurality of substantially evenly spaced radially oriented fluid transfer openings about said periphery.

19. The formable cushioned tubular fluid handling appliance of claim 18, comprising:
(a) said distal end of said flexible cushioning tip having a center; and
(b) said plurality of substantially evenly spaced radially oriented fluid transfer openings each being in the form of narrow slots extending from said cylindrical portion of said flexible cushioning tip and curving toward said center.

20. The formable cushioned tubular fluid handling appliance, comprising:
(a) an elongate tubular element defining a flow passage and having a connection end and a distal end and having sufficient flexibility for bending thereof to a desired configuration, said distal end defining a fluid inlet opening of said flow passage of said elongate tubular element; and
(b) a flexible cushioning tip having a tubular portion being disposed about said distal end and being of sufficient thickness to present a cushioned external surface for contact with a patient, said flexible cushioning tip defining an end opening permitting transfer of fluid therethrough and into said fluid inlet opening of said flow passage; and
(c) a length of formable structural material being fixed within said elongate tubular element and extending longitudinally thereof, said length of formable structural material being sufficiently pliable to permit bending of said cushioned tubular fluid handling appliance to a desired configuration and of sufficient structural integrity to maintain said cushioned tubular fluid handling appliance at the desired configuration.
